(19) United States
(12) Patent Application Publication
(10) Pub. No.: US 2007/0017738 A1
(43) Pub. Date: Jan. 25, 2007

(54) Damper with rotary valve

(76) Inventor: James Walter George Truss, Queensland (AU)

Correspondence Address: Abelman Frayne & Schwab, 666 Third Avenue, 10th Floor, New York, NY, 10017-5621, US

(21) Appl. No.: 10/545,337

(22) PCT Filed: Feb. 10, 2004
(86) PCT No.: PCT/AU04/00144

§ 371 Date: Sep. 5, 2006

(30) Foreign Application Priority Data
Feb. 11, 2003 (AU) 2003900610

(51) Int. Cl. F16F 15/00; F16F 9/54

(52) U.S. Cl. 181/209; 188/322.2

(57) ABSTRACT

A fire damper for sealing a conduit which extends through a concrete slab to prevent fire and toxic gases from passing from one side of the slab to the other, includes a housing which has a partially spherical rotatable valve. The rotatable valve has an internal passageway of substantially the same diameter as an internal diameter of the conduit. The rotatable valve is rotatable within the housing between an open orientation whereby fluid flow through the damper is substantially unimpeded and a closed orientation. The rotatable valve is actuated by a heat detector in the form of two rings of lead alloy located between the housing and the rotatable valve. The damper may also include a deformable seal disposed between the housing and the rotatable valve.

This invention relates to a device for preventing fire and/or smoke, toxic gases and the like from spreading from one side of a barrier, such as a wall, floor, partition or the like, in a structure, to the other side, through an aperture which extends through the barrier. In particular, the invention is primarily concerned with an improved form of fire damper for location in concrete slabs forming the floors and walls of multi-storey buildings.

There are in general two types of devices which are used to prevent fire from spreading through apertures, normally constituted by or being associated with pipes, conduits or ducts in walls, floors, partitions and the like: fire dampers and fire collars.

Fire collars are usually employed with pipework or ducting which is formed from a deformable material including a plastics material such as PVC, rubber, or a deformable metal or composite material. A common type of fire collar comprises a metal collar which is fastened around a concrete slab-penetrating pipe formed from a plastics material, in the region where it traverses the slab. The collar encloses an intumescent material. When a fire on one side of the concrete slab reaches a sufficient intensity, it causes the intumescent material to expand, which in turn collapses or pinches off the deformable pipe. In this way, fire is prevented from spreading to the other side of the concrete slab by passing through the conduit. Examples of such fire collars are described in U.S. Pat. No. 5,058,346 and U.S. Pat. No. 5,347,767.

Fire dampers are generally located in a barrier and are connected to pipework or ducting. They include a passage which may be closed by a valve arrangement when a fire on one side of the barrier triggers a heat detector incorporated in the damper. An example of this type of fire damper is described in WO 03/023267 A1.

WO 03/023267 A1 describes a fire damper which is positioned in pipework or ducting at the location where the pipework or ducting traverses a barrier such as a partition. The fire damper has a housing incorporating a damper arrangement and a heat detector. The damper arrangement is designed to normally enable unimpeded flow of fluid through the pipework or ducting, but to seal off the pipework or ducting when the heat detector reacts to a preset temperature value.

The damper includes a cylinder or ball valve having an internal passageway which is of substantially the same diameter to that of the pipework or ducting. The cylinder or ball valve is rotatable between an open position where the passage of fluid through the pipework or ducting is unimpeded, and a closed position, whereby the passage of fluid is restricted. In a preferred configuration, an intumescent material is disposed within the cylinder or ball valve such that after a period the intumescent material expands to provide a further seal for the pipework or ducting. The delay in the expansion of the intumescent material can allow smoke or toxic fumes to pass through the cavity between the cylinder or ball valve and the housing.

It is an object of the invention to provide an improved form of fire damper.

The invention provides a damper for sealing a conduit which extends through a barrier, said damper comprising a housing and a rotatable valve located in said housing, said rotatable valve having an internal passageway of substantially the same diameter as an internal diameter of said conduit, said rotatable valve being rotatable within said housing between an open position in which fluid flow through said damper is substantially unimpeded and a closed position in which fluid flow through said damper is substantially impeded, said rotatable valve being actuated by a detector to move from said open position to said closed position, characterised in that said detector is a heat detector is constituted by material positioned between said housing and said rotatable valve, said material being adapted to yield when a predetermined temperature is reached, allowing said rotatable valve to move to said closed position.

The invention also provides a damper for sealing a conduit which extends through a barrier, said damper comprising a housing and a rotatable valve located in said housing, said rotatable valve having an internal passageway of substantially the same diameter as an internal diameter of said conduit, said rotatable valve being rotatable within said housing between an open position in which fluid flow through said damper is substantially unimpeded and a closed position in which fluid flow through said damper is substantially impeded, said rotatable valve being actuated by a heat detector to move from said open position to said closed position, characterised by a deformable seal disposed between said housing and said rotatable valve such that when said rotatable valve is in said closed position, said deformable seal prevents fluid flow between said housing and said rotatable valve.

The invention further provides a damper for sealing a conduit which extends through a barrier, said damper comprising a housing and a rotatable valve located in said housing, said rotatable valve having an internal passageway of substantially the same diameter as an internal diameter of said conduit, said rotatable valve being rotatable within said housing between an open position in which fluid flow through said damper is substantially unimpeded and a closed position in which fluid flow through said damper is substantially impeded, said rotatable valve being actuated by a detector to move from said open position to said closed position, characterised by a fusible link mechanism, said mechanism having an actuator including a shaft, a lever and a pivot pin assembled on a mount, said shaft being mounted through said mount and being driveably connected to said rotatable valve, said lever being connected to said shaft, said pivot pin normally retaining said lever in an open orientation with said rotatable valve, a fusible link retaining said pin in position such that when said fusible link is heated to a predetermined temperature, said fusible link yields, permitting said pivot pin to be rotated out of engagement with said lever, enabling said rotatable valve to rotate to said closed position.

Throughout this specification, the term “barrier” is to be taken to mean a wall, a floor (particularly a slab floor of the type used in multi-storey buildings), a partition or the like, which are features of structures such as buildings. Throughout this specification, the term “conduit” is intended to refer to an aperture, a pipe, pipework, a conduit, a duct, or the like, features of structures such as buildings, particularly in the context of extending through a barrier.

It will be understood by those skilled in the art that the term “fluid” is intended to mean gases, such as air-conditioning air, waste gases, and liquids such as liquid wastes and water.

Throughout this specification, the term “fire damper” and the term “damper” are each to be taken to mean a device adapted to act as a closure to seal an aperture, such as a conduit, which extends through a barrier, to prevent fire, fluids and the like from spreading from one side of the barrier to the other side, through the aperture.

Advantageously, the closure of the present invention not only provides a fire damper which is effective in closing a conduit formed by pipework, ducting or the like so as to prevent, or restrict the passage of fire therethrough, the closure also provides a sealing mechanism which is able to prevent the passage of smoke and toxic gases therethrough. The ability of the closure of the present invention to prevent the passage of smoke and toxic gases therethrough permits its use in other applications or provides further advantages. For example, by placing a toxin detector within the pipework or ducting, or adjacent one or more intakes the detection of a toxin can actuate the closure and prevent or limit contamination through the pipework or ducting.

Preferably, the rotatable valve is in the form of a cylinder or ball valve having an internal passageway which is of the same or similar diameter to that of the pipework, ducting or conduit in which it is fitted, or to which it is connected. The cylinder or ball valve is arranged so as to be rotatable about an axis between a normal open position where passage of fluid through the pipework or ducting is unimpeded to a position, generally at right angles to the open position, where passage of fluid prevented.

Rotation of the cylinder or ball valve can be achieved by mechanical and/or electrical means. Mechanical rotation can be, for instance, by the use of a spiral spring retained in a recess formed in an exterior wall of the housing, having its outer end held by the housing and its inner end held by the cylinder or ball valve. In its normal configuration, the spring is under tension but it cannot rotate the ball or cylinder to a closed position until actuated by the detector. The closed position can be established by a pin located in the housing wall which meets a stop when rotation through 90° has been made.

Alternatively the rotatable valve may be driven by electrical means. In such an embodiment the detector may be remote from the damper. For example, the detector may be in the form of a thermal or smoke detector located within a building. Once the smoke or thermal detector is tripped, the detector actuates an electric motor causing the valve to rotate to the closed orientation.

The rotatable valve may also be closed by a combination of mechanical and electrical means. For example, an electric motor may operate the rotatable valve in response to output from a first set of detectors such as remote smoke or fire detectors, and a fusible or frangible linkage may be provided between the motor and the valve, which linkage may be broken by heat. The rotatable valve may be biased by a spring or the like to the closed position.

In one form of the invention, the heat detector can be formed from a material which has the dual properties of, firstly, being capable of bonding or interlocking with an element of the damper arrangement and the housing and, secondly, being able to yield its bond or lock when it is heated to a predetermined temperature value. These properties enable the heat detector to be designed and located in such a manner that it will normally ensure that the damper arrangement is held open but when a predetermined, that is, pre-set, temperature is reached, it will yield, enabling the damper arrangement to close.

Suitable heat detector materials are lead and its alloys, plastics materials and various composites. Typically, the temperature at which such materials yield will be in the range of 60° C. to 120° C., depending upon the particular application, so as to meet governmental or local council requirements.

The heat detector material can be located, for instance, in the interior perimeter of the housing where an element of the damper arrangement has an adjacency when in an open configuration. Thus, in the case of a ball valve, a circular seal of heat detector material, such as a ring of lead, may be located between the housing and the ball valve at both the inlet and outlet sides.

In another form, the heat detector material can comprise an alloy pad formed on the end of a bearing shaft which extends through the wall of the housing to a location within the damper arrangement, preferably at a location which does not impede the flow of fluid through the housing. A spiral spring retained in a recess on the outer side of the housing connects the shaft to the housing. The spring is normally held under compression and is only released from compression when the alloy pad yields upon being heated to the pre-set temperature, thereby enabling the shaft and damper to rotate to a closed position.

In yet another form of the invention, the heat detector may be a thermocouple. The thermocouple can be connected by way of appropriate circuitry to a solenoid which retracts a pin extending between the housing and the damper arrangement, to permit the damper arrangement to close when the thermocouple detects a predetermined temperature value. Such a situation also permits the damper to be reset to an open configuration as well as facilitating the simultaneous operation of other fire dampers within the partition.

In order to test the integrity of the fire damper arrangement, testing means can be provided which enable the damper to be moved between its open and closed configurations. Such testing means may be automatic or manual. An automatic testing means may comprise a motor which drives, for instance, the aforementioned bearing shaft so as to rotate the attached damper. A manual testing means can consist of a simple lever fitted to the bearing shaft.

The fire damper according to the present invention is ideally fabricated from ceramic materials but other materials such as fibre-reinforced concrete, metal and the like can also be used, depending upon the specific usage. Preferably, the damper arrangement incorporates a cylinder or ball made from plastics material having an intumescent material embedded between inner and outer layers of the plastics material. The intumescent material expands when the cylinder or ball has rotated to its closed position, thereby providing an additional fire-stop feature.

The housing preferably closely encases the rotatable valve such that there is little gap therebetween, sufficient to allow the rotatable valve to operate freely therein, whilst minimising flow of fluid between the housing and the valve.

A deformable seal may be disposed between the housing and the rotatable valve. The deformable seal may be mounted on the housing or the rotatable valve. It is preferred that the deformable seal is mounted on the housing. In a preferred embodiment, deformable seals are provided on the housing adjacent both ends of the rotatable valve. This is particularly advantageous in maintaining the integrity of the seal during fire. The closure acts to prevent fire or fumes passing from one side of the closure to the other. Whilst the deformable seal on the “hot” side of the closure may be destroyed or damaged due to the heat, the seal on the remote side of the closure is more likely to maintain its integrity.

The deformable seal preferably has a seat for fixed engagement with the housing, such as within a recess or over a rib. The deformable seal preferably has one or more flanges extending from the seat for sealing engagement with the rotatable valve.

The deformable seal may be formed from rubber or similarly flexible plastics materials. In a preferred configuration the deformable seal is formed in a co-moulding where the seat of the seal is formed from a hard formulation of rubber or rubber-like material and one or more extending flanges for engagement with the rotatable valve are formed from a softer, more readily deformable, rubber or rubber-like material.

Usage of the fire damper of the present invention can range across a large number of fields from plumbing to ventilation, and air-conditioning installations.

In one application, the closure of the present invention may be used for venting selected areas of a building. At various times throughout a day, the venting requirements may differ. For example, during periods of high activity within selected areas of a building, the venting requirements may be high whilst during other periods minimal or no venting is required. The venting of a building requires the use of fans or the like. The operation of the fans must accommodate the maximum venting requirements. The closure of the present invention conveniently allows a more intelligent operation of a venting system whereby the fan or fans may be operated as required. The damper or closure of the present invention may be fitted with a motor drive allowing the rotatable valve to be maintained in an open or partially open condition whereby the volume of fluid able to flow through the closure is controlled. Thus, in low demand periods the closure may be maintained in a partially open state and the fan or fans may be operated at a correspondingly reduced level. The closure of the present invention permits not only protection against fire, smoke and toxic fumes generated by fires but may also be able to be used in preventing contamination of a building through the ventilation system. A toxin sensor may be positioned within the ventilation system whereby on detection of a toxin the closures are shut such that the deformable seals prevent or limit contamination across the closures.

A damper in accordance with the present invention, in which electric means such as a solenoid or an electric motor are involved in the operation the rotatable valve, may also operate such that in the event of a power outage, the rotatable valve is closed to prevent smoke and gases such as toxic gases from passing through a barrier such as concrete slab. Thus, even where a fire is not close to any heat detector associated with a damper, and even where the previously-described toxin sensor is not tripped due to the presence of toxins or the like because they have not yet reached the detector, the damper is able to be closed well in advance of the appearance of smoke, gases and the like on one side of the slab. A power outage could trigger action to close the rotatable valve in a number of ways, including the use of a solenoid to withdraw a detent holding the valve against spring action, the use of battery power to operate the electric motor to close the valve, and so on.

An electric motor involved in the operation of a damper according to the present invention may be remotely located with respect to the housing of a damper. For example, in the case of a damper located in a floor slab, the motor may be located beneath the floor slab, with transmission means such as a chain drive connecting the motor and the rotatable valve.

The closure of the present invention has application in a variety of structures including buildings, particularly multi-storey buildings. Other applications for the use of dampers or closures in accordance with the present invention include on board ships where ventilation is required through compartments and bulkheads whilst preventing fire, smoke, and toxins passing through the ventilation system.

Embodiments of the invention will be described in detail hereinafter, with reference to the accompanying drawings, in which:—

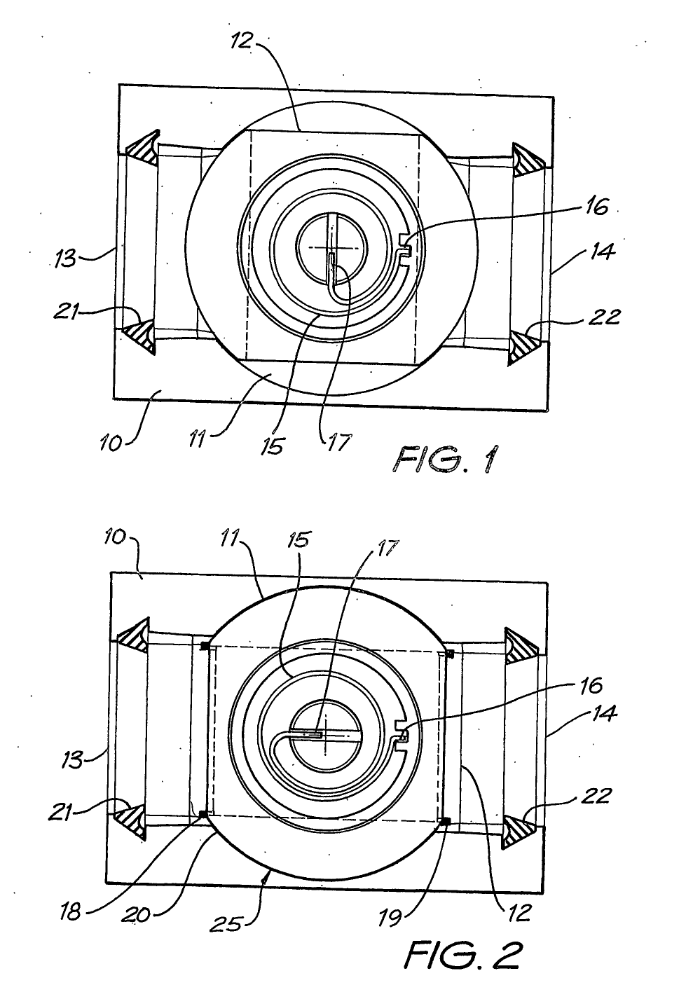

FIG. 1 is a top view of one embodiment of a fire damper according to the present invention, in a closed orientation;

FIG. 2 is a top view of the fire damper of FIG. 1, in an open position;

FIG. 3 is an end view of the fire damper of FIG. 1;

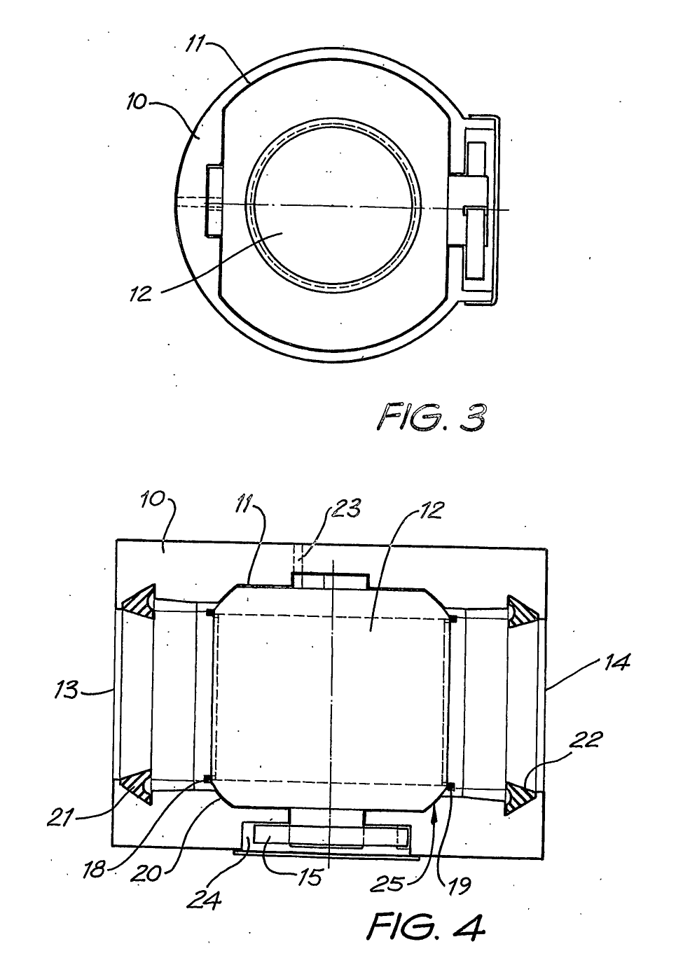

FIG. 4 is a side view of the fire damper of FIG. 1;

FIG. 5 is a cut-away view of a fire damper showing a deformable seal mounted between the housing and the rotatable valve;

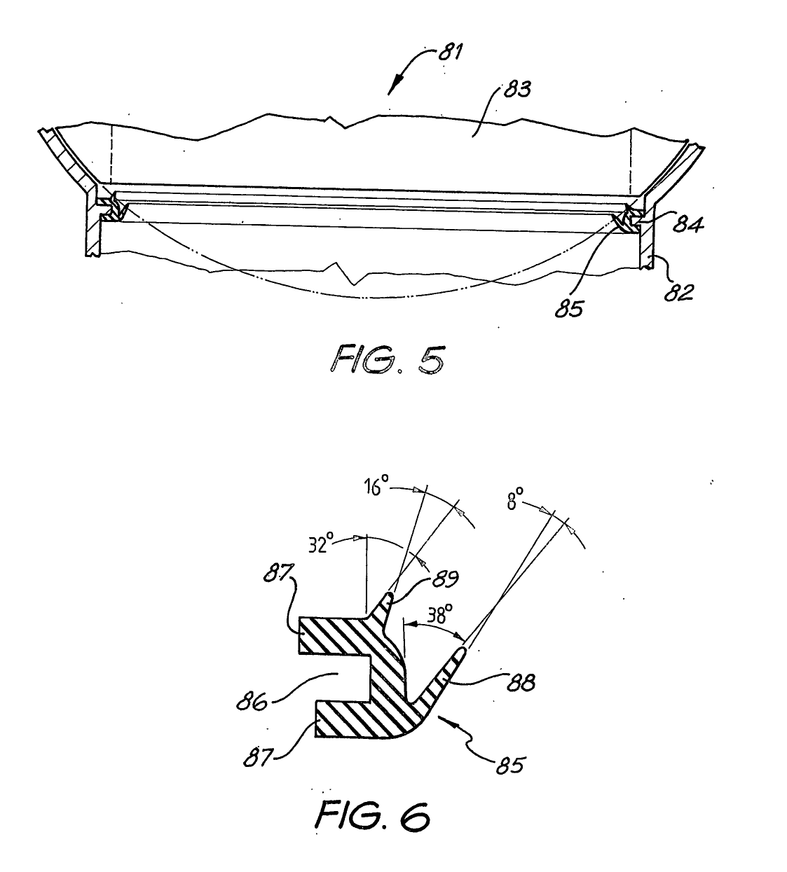

FIG. 6 is a cross-section of the deformable seal of FIG. 5;

FIG. 7 is a side elevation a further embodiment of fire damper according to the present invention.

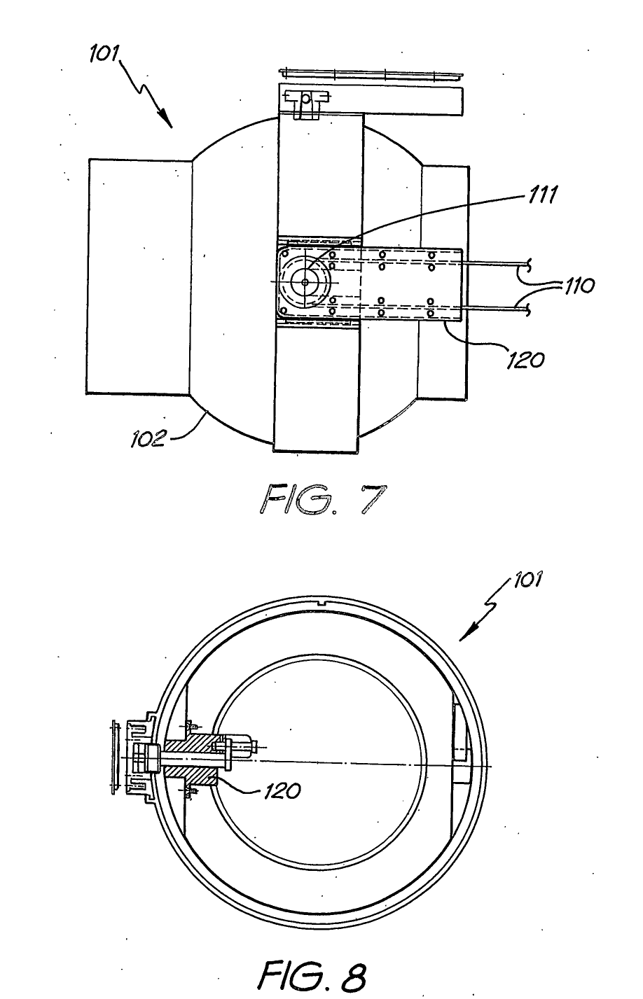

FIG. 8 is a cut-away view of the fire damper of FIG. 7;

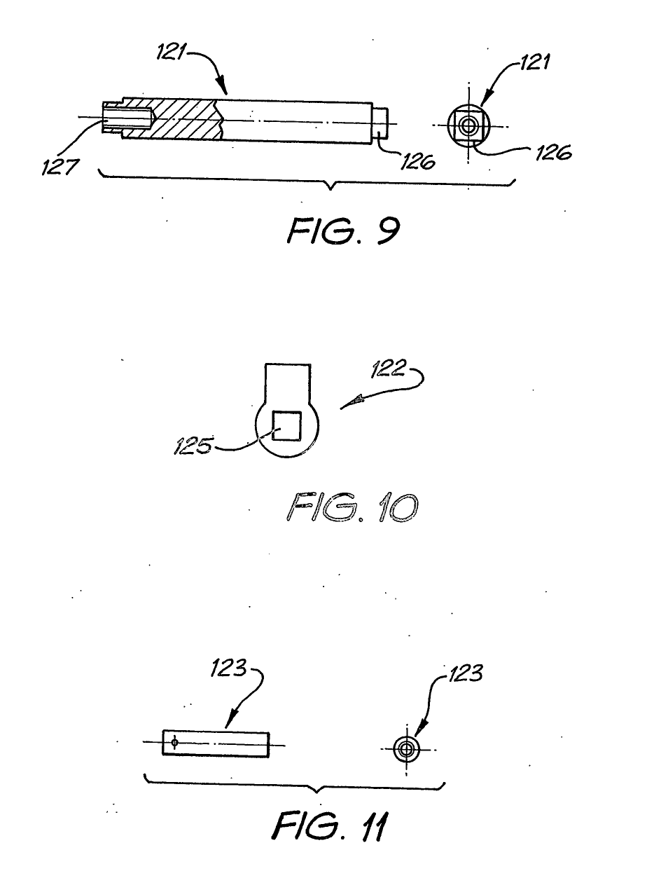

FIG. 9 shows a partially-sectioned side elevation and an end elevation of a shaft which is a component of a fusible link actuator mechanism for the embodiment of FIGS. 7 and 8;

FIG. 10 is an end elevation of a lever which is a component of a fusible link actuator mechanism for the embodiment of FIGS. 7 and 8;

FIG. 11 shows a side elevation and an end elevation of a pivot pin which is a component of a fusible link actuator mechanism for the embodiment of FIGS. 7 and 8;

FIG. 12 shows a section through and an end elevation of a fusible link actuator mechanism for the embodiment of FIGS. 7 and 8;

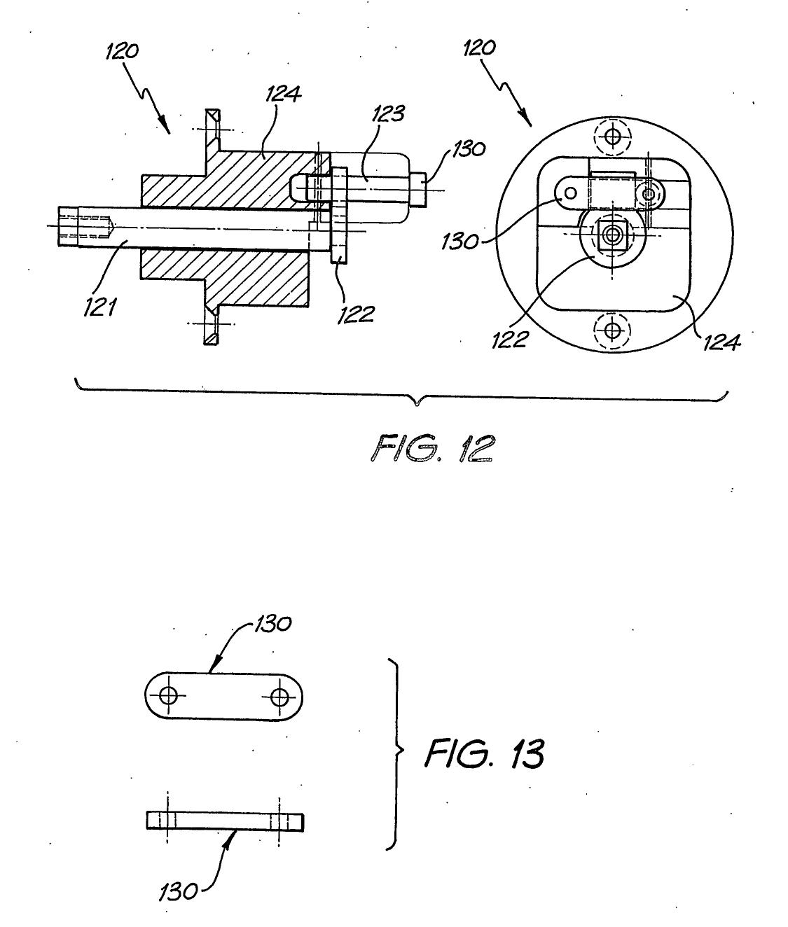

FIG. 13 shows a side elevation and plan view of a fusible link which is a component of a fusible link actuator mechanism for the embodiment of FIGS. 7 and 8;

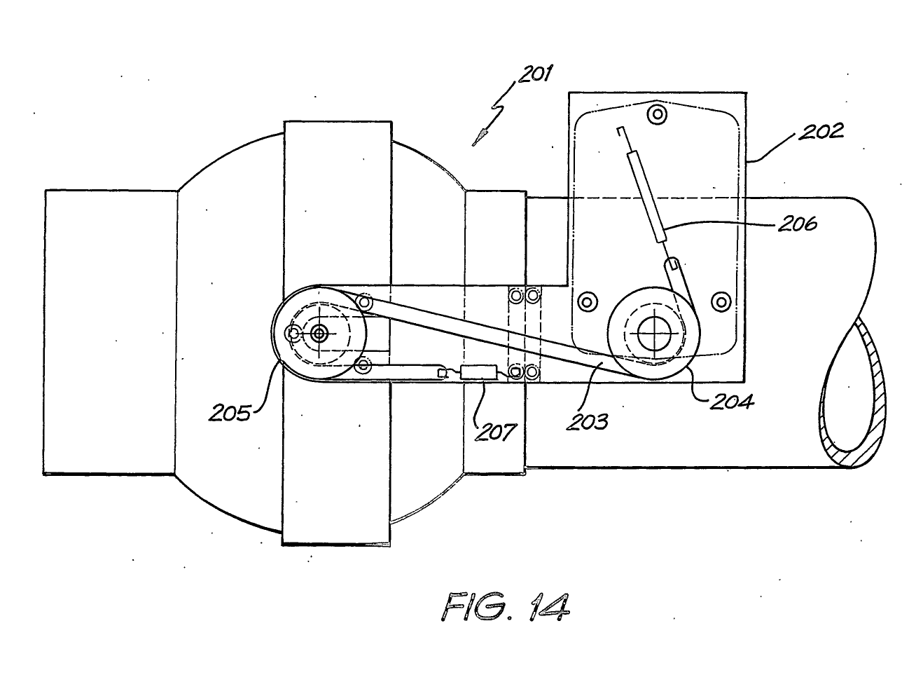

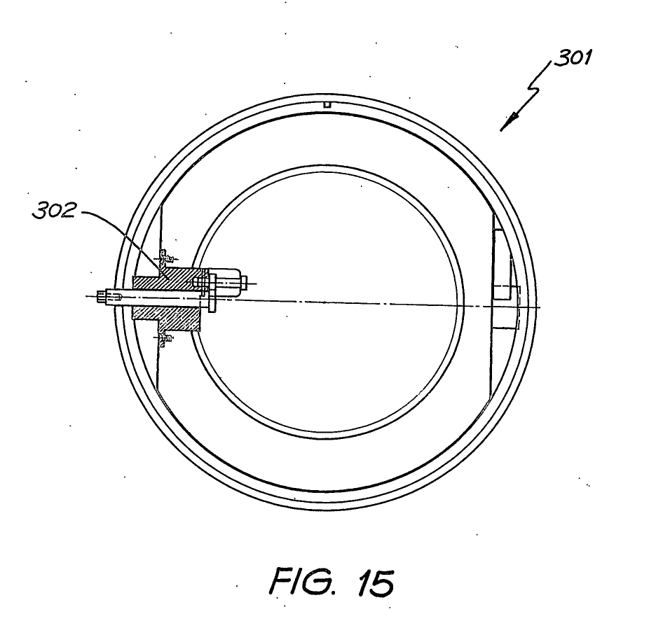

FIG. 14 is a side elevation of a fire damper according to the present invention, showing part of a drive mechanism from an electric motor; and

FIG. 15 is a cross-section through a fire damper in accordance with the present invention, at right angles to the axis of the damper, showing the location of a fusible link mechanism.

Referring firstly to FIGS. 1 to 4, the fire damper of one embodiment of the invention according to the present invention comprises a ceramic housing 10 having a partially spherical ceramic ball valve 11. “Partially spherical” means that the ball valve has two opposing sectors removed, as can be seen in FIG. 3, centrically located therein. The ceramic housing 10 may be formed by heat welding two hemispheres together after the ball valve 11 has been located therein.

The spherical ball valve 11 has a passageway 12 extending from one side to the other with a diameter which corresponds to the diameter of the housing inlet 13 and housing outlet 14. The housing inlet 13 and outlet 14, in turn, have diameters which do not impede the flow of fluid therethrough from pipework, conduits or ducting connected to the fire damper. Accordingly, unimpeded fluid flow is possible through the fire damper.

A recess 24 is formed in the outer wall of the ceramic housing 10 and a stainless steel spiral spring 15 is located therein. The spiral spring 15 has one end 16 bent so as to be retained within a hub of the housing 10, and the other end 17 of the spring 15 is cranked for retention by the ball valve 11.

Two rings 18, 19 of lead alloy are bonded between the housing 10 and the ball valve 11, and additionally seal the end of the small gap 20 between the ball valve 11 and its seat 25. The gap 20 can be maintained by small ridges formed on the surface of the ball valve 11. Such a gap is useful for preventing binding between the ball valve 11 and its seat 25, which may occur over time.

Elastomeric seals 21, 22 enable quick secure fractional attachment to a plastics material ventilation pipe (not shown) extending from a toilet or similar odour producing facility.

The fire damper depicted in FIGS. 1 to 4 is designed to be located within a concrete slab (not shown) of a high rise building. In use, the fire damper will maintain the open configuration shown, for instance, in FIG. 2 until such time as a fire occurs on either side of the concrete slab. When the fire reaches the ventilation-hydraulic pipe at the point of attachment to the fire damper, and the temperature climbs to a pre-set or predetermined value, the lead alloy ring seals 18, 19 melt and the ball valve 11 is then free to rotate under the tension of the spiral spring 15. Rotation continues until the passageway 12 in the ball valve 11 is in alignment with the housing inlet 13 and housing outlet 14, at which point a stop pin 23 in the ball valve 11 quadrant prevents further rotation.

Referring to FIGS. 5 and 6, a cut-away section of a fire damper of another embodiment of the present invention is shown. The damper 81 includes a housing 82 having a rotatable ball valve 83 disposed therein. The rotatable ball valve 83 is shown in solid form in the open orientation and in hashed relief in the closed orientation. The housing 82 has a rim 84 extending inwardly therefrom. A deformable seal 85 is mounted fixedly over the rim 84. The deformable seal 85 has a seat 86 formed by a pair of opposed legs 87. From the seat 86 there extends flanges 88 and 89. Flanges 88 and 89 sealably engage the rotatable ball valve 83 in the closed orientation in hashed relief.

FIGS. 7 to 13 show a further embodiment of the fire damper of the present invention. Fire damper 101 includes a casing 102 within which a pivotally mounted ball valve (not shown) is adapted to be mounted. The pivotally mounted ball valve may be rotated using wires 110 over pulley 111. The wires 110 and pulley 111 are boxed in a housing 120. The housing 120 includes intumescent material (not shown).

Reference is now made to FIG. 12, which shows a section and an end elevation of a fusible link mechanism 120, and to FIGS. 9 to 11 and 13, which show views of the components of the mechanism 120. The closure/damper 101 includes the fusible link mechanism 120. The fusible link mechanism 120 is formed from a shaft 121, a lever 122 and a pivot pin 123 assembled on a mount 124. The shaft 122 is mounted through the housing 124. The shaft 121 is driveably connected (through engagement with recess 127) to the rotating ball valve. At the other end of the shaft 121 there is a lever 122 fixedly connected to the shaft using a square aperture 125. The square aperture 125 engages with a square tab 126 on the shaft 121. The pivot pin 123 retains the lever 121 in a desired or open orientation with the ball valve. A fusible link 130 (FIG. 13) retains the pin 123 in position such that upon heating of the fusible link, the fusible link melts and permits the pivot pin 123 to be rotated out of engagement of the lever 122, enabling the rotating ball valve to rotate to a closed position.

In FIG. 14, there is shown a further embodiment of a fire damper according to the present invention. The fire damper 201 of FIG. 14 is intended to be generally very similar to the fire damper of FIGS. 1 to 4 and to damper 101. In the embodiment of FIG. 14, an electric motor 202 operates the rotatable valve (not shown) by means of a drive mechanism which includes a wire, band, chain or the like 203. The chain or the like 203 runs over a first pulley 204 which is connected to the drive shaft (not shown) of the motor 202, and a second pulley 205 connected to the rotatable valve and adapted to rotate the valve between an open position and a closed position. As shown in FIG. 14, the chain or the like 203 describes an angle greater than 90° around pulley 204, and an angle greater than 180° around pulley 205.

The chain or the like 203 may be kept under tension by one or more springs, such as springs 206, 207. In that way, rotation of the pulley 204 by the motor 202 will rotate pulley 205 to close the rotatable valve. Preferably, the rotation of pulley 204 is anti-clockwise to move the rotatable valve from an open position to a closed position.

As mentioned earlier in this specification, the motor 202 may be located remotely in relation to damper 201. For example, if damper 201 is located in a floor slab, the motor 202 may be located beneath the slab. The pulleys 204, 205 may be provided with sprockets or the like, to engage with the chain 203, if a chain is selected to drive the rotatable valve.

FIG. 15 is similar to FIG. 8, and shows the preferred location for fusible link actuation means 302 within a fire damper 301, which is generally very similar to the fire damper of FIGS. 1 to 4, to damper 101, and to damper 201. The means 302 is similar to that described in relation to FIGS. 9 to 13, is adapted to be located to one side of the interior of damper 301, and is adapted to be connected to a rotatable valve (not shown).

The entire contents of the specification (including the drawings) of Australian provisional patent application no. 2003900610, filed on 11 Feb. 2003, are hereby incorporated into the present specification. The claims form part of the disclosure of this specification.

1. A damper for sealing a conduit which extends through a barrier, said damper comprising:
a housing; and
a rotatable valve located in said housing, said rotatable valve having:
an internal passageway of substantially the same diameter as an internal diameter of said conduit, said rotatable valve being rotatable within said housing between an open position in which fluid flow through said damper is substantially unimpeded and a closed position in which fluid flow through said damper is substantially impeded, said rotatable valve being actuated by a detector to move from said open position to said closed position;
wherein said detector is a heat detector constituted by heat deformable material positioned between said housing and said rotatable valve, said heat deformable material being adapted to yield when a predetermined temperature is reached, thereby allowing said rotatable valve to move to said closed position.

2. A damper according to claim 1, wherein said heat deformable material is constituted by at least one ring.

3. A damper according to claim 2, wherein said heat deformable material is constituted by two rings.

4. A damper according to claim 2, wherein said heat deformable material is a lead alloy.

5. A damper according to claim 1, wherein said heat deformable material is also located at the end of the gap between said rotatable valve and the seat for said rotatable valve, to seal said end.

6. A damper according to claim 1, further comprising:
a deformable seal disposed between said housing and said rotatable valve such that when said rotatable valve is in said closed position, said deformable seal prevents fluid flow between said housing and said rotatable valve.

7. A damper according to claim 6, wherein said deformable seal is mounted on said housing.

8. A damper according to claim 6, wherein said deformable seal is mounted on said rotatable valve.

9. A damper according to claim 6, wherein two said deformable seals are provided adjacent respective ends of said rotatable valve.

10. A damper according to claim 7, wherein said deformable seal has a seat for fixed engagement with said housing.

11. A damper according to claim 7, wherein said seat is adapted to cooperate with a recess in, or with a rib on, said housing.

12. A damper according to claim 11, wherein said seat is adapted to with a recess in, or with a rib on, said housing.

13. A damper according to claim 12, further comprising a flange extending from said seat for sealing engagement with said housing.

14. A damper according to claim 1 wherein said seal is formed from a flexible material selected from the group consisting of natural rubber, synthetic rubber, and plastic.

15. A damper according to claim 13, wherein said seal is formed from a co-molding in which the base of the seal is formed from a hard formulation of rubber or natural synthetic rubber, and said flange is formed from a softer, more readily deformable, natural or synthetic material.

16. A damper according claim 1, further comprising:
a fusible link mechanism, said fusible link mechanism having:
an actuator including.
a shaft,
a lever,
a pivot pin assembled on a mount, said shaft being mounted through said mount and being driveably connected to said rotatable valve, said lever being connected to said shaft, said pivot pin normally retaining said lever in an open orientation with said rotatable valve, and
a fusible link retaining said pin in position such that, when said fusible link is heated to a predetermined temperature, said fusible link yields, permitting said pivot pin to be rotated out of engagement with said lever, whereby said rotatable valve rotates to said closed position.

17. A damper according to claim 3, wherein said heat deformable material is a lead alloy.

18. A damper according to claim 9, wherein said deformable seal has a seat for fixed engagement with said housing.

19. A damper according to claim 9, wherein said seat is adapted to cooperate with a recess in, or with a rib on, said housing.

20. A damper according to claim 14, wherein said seal is formed from a co-molding in which the base of the seal is formed from a hard formulation of natural rubber or synthetic rubber, and a flange extending from said seat for sealing engagement with said housing is formed from a softer, more readily deformable, natural or synthetic material.
